(19) United States
(12) Patent Application Publication
(10) Pub. No.: US 2010/0235225 A1
(43) Pub. Date: Sep. 16, 2010

(54) AUTOMATIC DETECTION OF SYSTEMATIC SALES PATTERNS USING AUTOCORRELATION TECHNIQUE

(76) Inventors: Arash Bateni, Toronto (CA); Edward Kim, Toronto (CA); Philippe Hamel, Lavel (CA); Stephen Chang, Waterloo (CA)

Correspondence Address: JAMES M. STOVER;TERADATA CORPORATION, 2835 MIAMI VILLAGE DRIVE, MIAMISBURG, OH, 45342, US

(21) Appl. No.: 12/686,279

(22) Filed: Jan. 12, 2010

Related U.S. Application Data
(60) Provisional application No. 61/143,912, filed on Jan. 12, 2009.

(51) Int. Cl. G06Q 10/00

(52) U.S. Cl. 705/10

(57) ABSTRACT

A method, based on autocorrelation techniques, for measuring the relative significance of the systematic versus random components of product sales data. The results of this determination can be used to improve product demand forecast and product seasonal profile determinations. When a product's sales variation is primarily due to systematic patterns, the accuracy of demand predictions and forecasts can be improved by understanding and modeling the underlying pattern. On the other hand, when variations in sales are merely random, these variations can be discounted when determining demand forecasts or product seasonal profiles.

### CROSS REFERENCE TO RELATED APPLICATIONS

This application claims priority under 35 U.S.C. §119(e) to the following co-pending and commonly-assigned patent application, which is incorporated herein by reference:

Provisional Patent Application Ser. No. 61/143,912, entitled “AUTOMATIC DETECTION OF SYSTEMATIC SALES PATTERNS USING AUTOCORRELATION TECHNIQUE” by Arash Bateni, Edward Kim, Philippe Dupuis Hamel, and Stephen Szu Chang; filed on Jan. 12, 2009.

This application is related to the following co-pending and commonly-assigned patent application, which is incorporated by reference herein:

application Ser. No. 10/724,840, entitled “METHODS AND SYSTEMS FOR FORECASTING SEASONAL DEMAND FOR PRODUCTS HAVING SIMILAR HISTORICAL SELLING PATTERNS,” filed on Dec. 1, 2003, by Edward Kim, Roger Wu, Frank Luo and Andre Isler.

### FIELD OF THE INVENTION

The present invention relates to methods and systems for forecasting product demand, and in particular to a method, based on autocorrelation concepts, to measure the relative significance of systematic versus random components of product sales data.

### BACKGROUND OF THE INVENTION

Accurate demand forecasts are crucial to a retailer's business activities, particularly inventory control and replenishment, and hence significantly contribute to the productivity and profit of retail organizations.

Teradata Corporation has developed a suite of analytical applications for the retail business, referred to as Teradata Demand Chain Management (DCM), which provides retailers with the tools they need for product demand forecasting, planning and replenishment. Teradata Demand Chain Management assists retailers in accurately forecasting product sales at the store/SKU (Stock Keeping Unit) level to ensure high customer service levels are met, and inventory stock at the store level is optimized and automatically replenished. Teradata DCM helps retailers anticipate increased demand for products and plan for customer promotions by providing the tools to do effective product forecasting through a responsive supply chain.

The Teradata Demand Chain Management suite of products models historical sales data to forecast future demand of products. Generating responsive demand forecasts depends upon the accurate calculation of demand and seasonality for retail products. The seasonal seasonal variation in demand for a product, referred to as the product's seasonal profile, is discussed in application Ser. No. 10/724,840, entitled “METHODS AND SYSTEMS FOR FORECASTING SEASONAL DEMAND FOR PRODUCTS HAVING SIMILAR HISTORICAL SELLING PATTERNS,” referred to above and incorporated by reference herein.

Not all variation in a product's sales patterns over time is due to seasonality. This variation can be due to a) systematic patterns, such as seasonality of demand, and b) random or irregular fluctuations. It is often desired to measure the significance of these components for a given product. When the products sales variation is primarily due to systematic patterns, the accuracy of demand predictions and forecasts can be improved by understanding and modeling the underlying pattern. On the other hand, when variations in sales are merely random, these variations are best discounted when determining demand forecasts or product seasonal profiles.

Described herein is a method, based on autocorrelation concepts, to measure the relative significance of systematic versus random components of product sales data.

### BRIEF DESCRIPTION OF THE DRAWINGS

FIG. 1 is a table illustrating a process for calculating autocorrelation of data with a lag, or distance between observations, of 1.

FIG. 2 is a table illustrating a process for calculating autocorrelation of multiple years of data using average data values.

FIG. 3 is a simple flow diagram illustrating a process for determining autocorrelation of demand in accordance with the present invention.

FIG. 4 is a scatter graph illustrating demand data where the variation in sales data is primarily due to random fluctuation.

FIG. 5 is a graph illustrating the systematic sales component and random, or irregular, data fluctuations of the normalized data of FIG. 4.

FIG. 6 is a scatter graph illustrating demand data where the variation in sales data is primarily systematic.

FIG. 7 is a graph illustrating the systematic sales component and random, or irregular, data fluctuations of the normalized data of FIG. 6.

FIG. 8 is simple flow diagram illustrating the use of autocorrelation measurements in the determination of demand forecasts.

FIG. 9 is simple flow diagram illustrating the use of autocorrelation measurements in the process for selecting a seasonal profile for a product.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

As stated above, products sales data varies over time due to systematic patterns, such as trend or seasonality of demand and random or irregular fluctuations. A method for measuring the relative significance of the systematic versus random components of the sales variation is desired in order to improve the accuracy of demand forecasts and seasonal profile selection. The accuracy of demand predictions and forecasts can be improved by understanding and modeling the underlying pattern when the pattern is systematic. On the other hand, when variations in sales are merely random, these variations are best discounted when determining demand forecasts or product seasonal profiles.

To determine the correlation of data, a number of consecutive sales data, e.g., weekly sales data values, values are required as input. The data can be weekly sales data for a partial year or multiple years. When multiple years of data is available the average weekly sales is calculated and used in the autocorrelation determination.

Autocorrelation coefficients measure the correlation between observations at different distances apart. The distance between the observations is called lag.

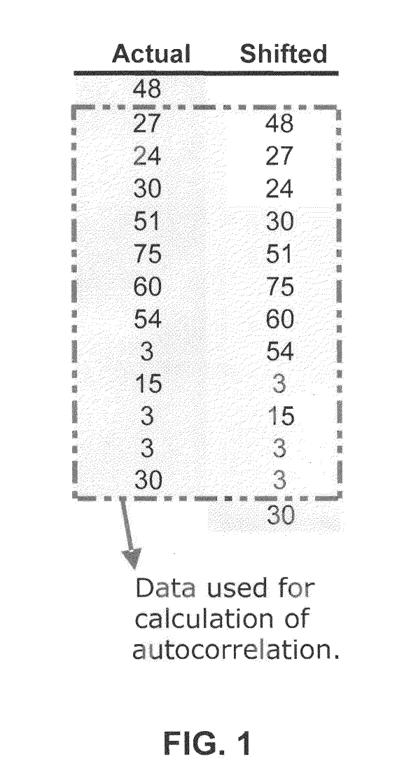

The table shown in FIG. 1 illustrates the process for calculating autocorrelation of data with a lag, or distance between observations, of 1. The data represents weekly sales data for a partial year. Utilizing a lag of 1, the demand at each week is compared with that of the previous week. An autocorrelation coefficient can be determined with the following equation:

$$AC = \frac{{\sum }_{w = 1}^{N - 1} ( {d}_{w} - \overline{d} ) ( {d}_{w - 1} - \overline{d} )}{{\sum }_{w = 1}^{N} {( {d}_{w} - \overline{d} )}^{2}} ,$$

where AC is the autocorrelation coefficient, d_{w} is a demand observation at week w, d_{w-1} is that demand observation at the week prior to week w, and d̅ is the average of the weekly demand observations.

It is recommended to use at least 10 week of consecutive data for calculation of the autocorrelation coefficient.

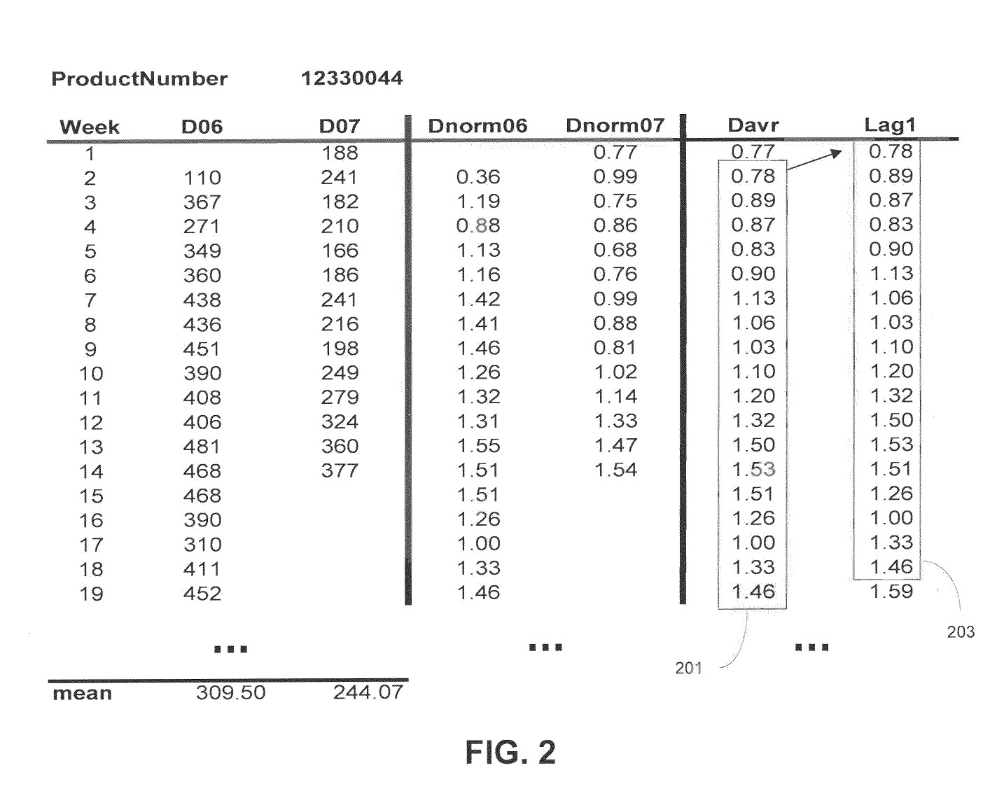

The table shown in FIG. 2 illustrates a process for calculating autocorrelation of multiple years of data using average data values. When multiple years of data is available, columns D06 and D07, the data should be normalized to remove the effect of year over year trend, columns Dnorm06 and Dnorm07, respectively, and then averaged, column Davr. The autocorrelation is then calculated from the averaged data.

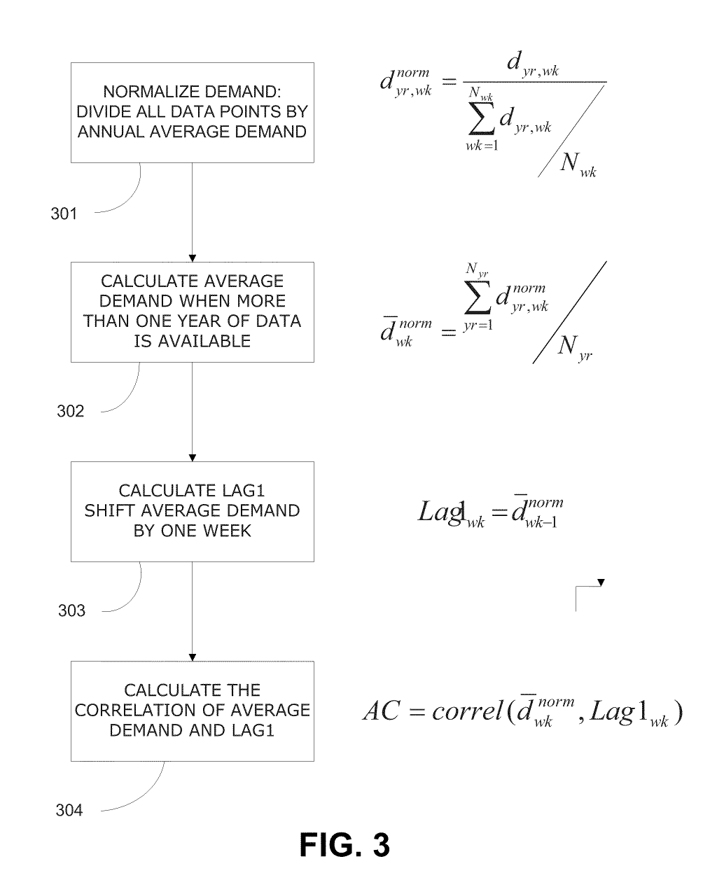

FIG. 3 provides a simple flow diagram illustrating this process for determining autocorrelation of demand. The first step 301 of the process, when multiple years of data are available, is to normalize the demand (FIG. 2, Dnorm06 and Dnorm07). Normalization is accomplished by dividing all data points by the annual average demand:

$${d}_{yr , wk}^{norm} = \frac{{d}_{yr , wk}}{{\sum }_{wk = 1}^{{N}_{wk}} {d}_{yr , wk} / {N}_{wk}}$$

In step 302, the average demand is calculated. When more than one year of data is available the average weekly demand (FIG. 2, Davr) is calculated:

$${\overline{d}}_{wk}^{norm} = {\sum }_{yr = 1}^{{N}_{yr}} {d}_{yr , wk}^{norm} / {N}_{yr}$$

In step 303, Lag1 is calculated by shifting the average demand by one week:

Lag1_{wk}= d̅_{wk-1}^{norm}

In step 304, the correlation of the average demand and Lag1 is calculated:

AC=correl( d̅_{wk}^{norm},Lag1_{wk})

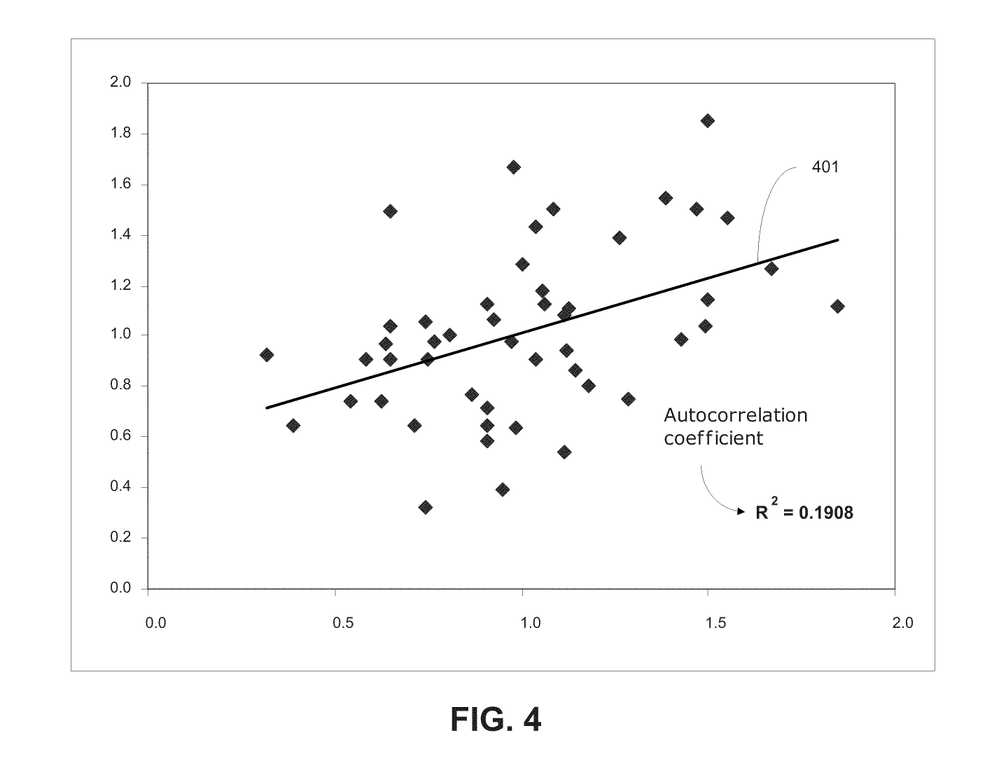

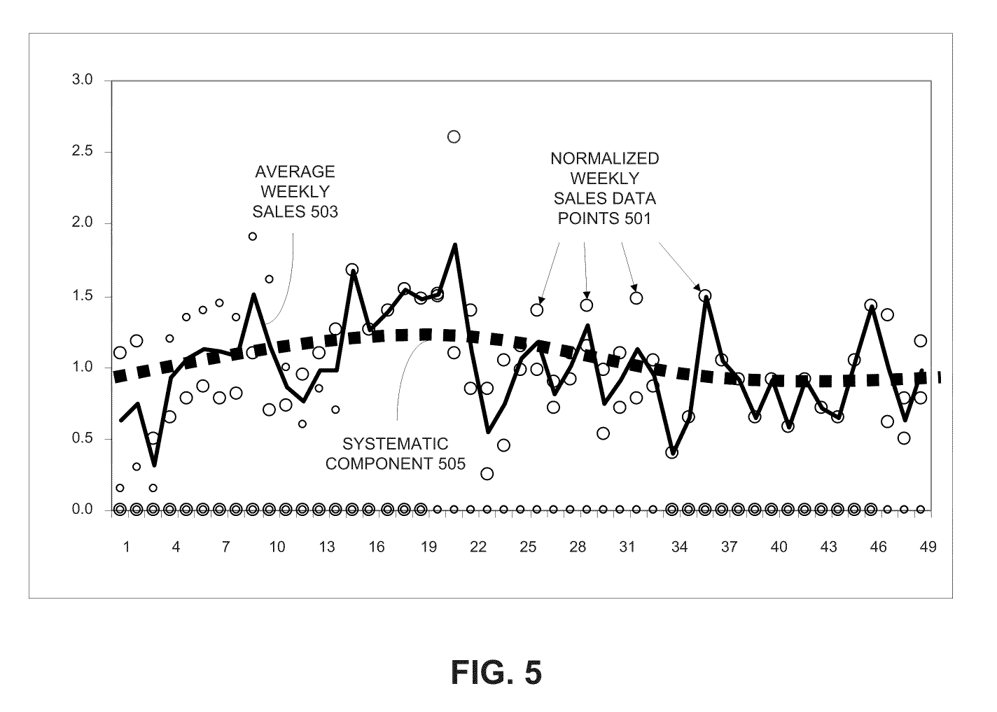

FIGS. 4 and 5 illustrate a case where the variation in sales data is primarily due to random fluctuation. FIG. 4 is scatter graph illustrating the demand distribution. The graph of FIG. 5 shows that the systematic sales component 505 is small relative to the irregular fluctuations, shown by the normalized weekly sales data points 501 and the graph of average weekly sales 503. The results of the autocorrelation analysis, the small correlation coefficient of 0.19 shown in FIG. 4, suggest a small systematic component.

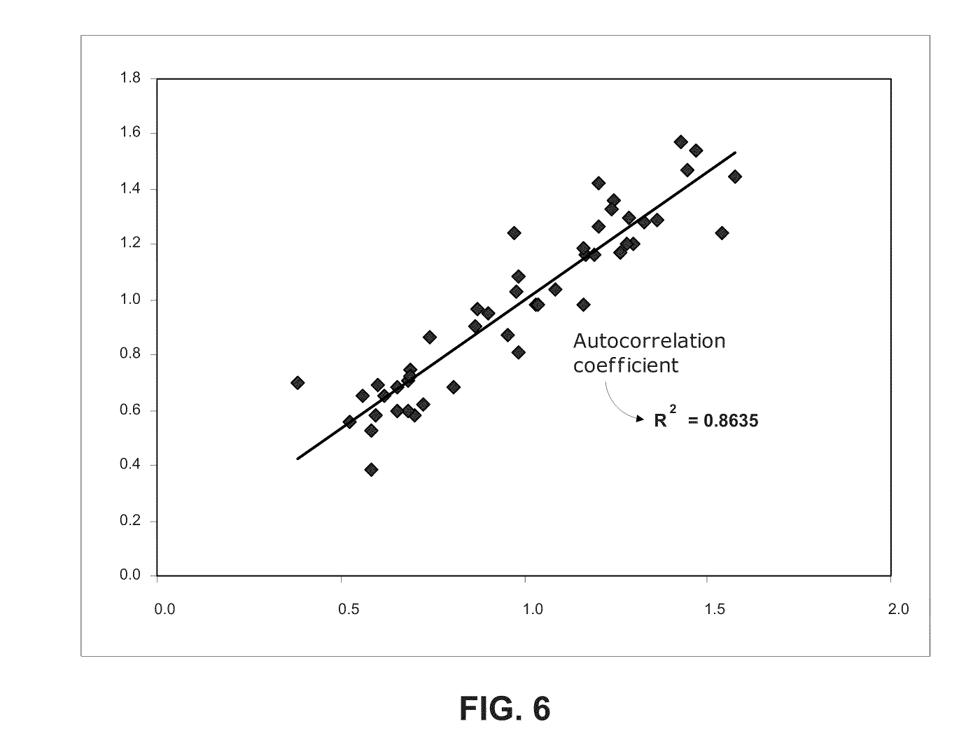

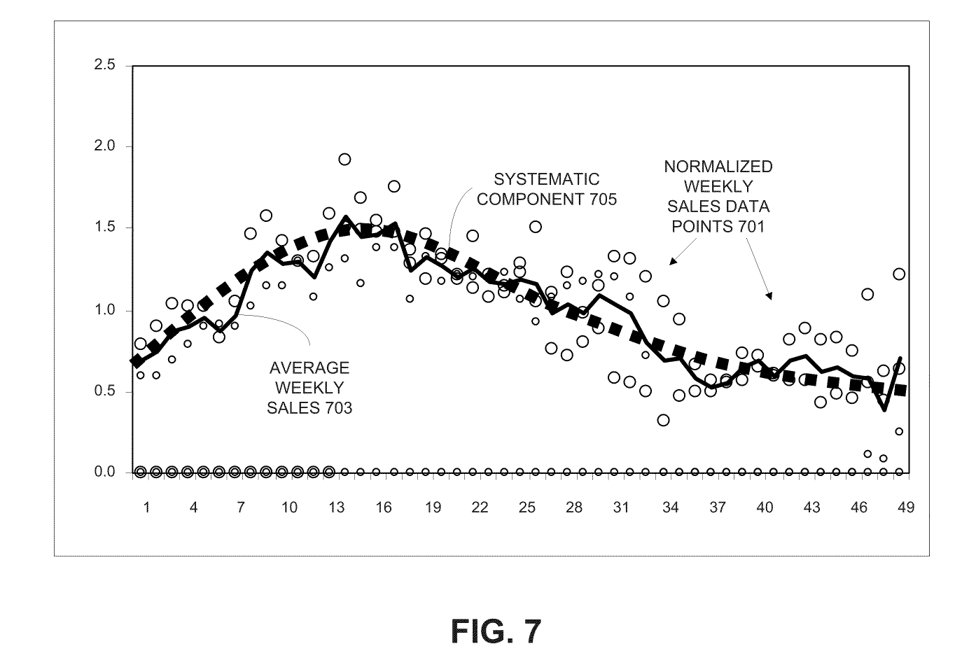

FIGS. 6 and 7 illustrate a case where the variation in sales data is mainly systematic. FIG. 6 is a scatter graph illustrating the demand data distribution. The graph of FIG. 7 shows that the systematic sales component 705 is large relative to the irregular fluctuations, shown by the normalized weekly sales data points 701 and the graph of average weekly sales 703. The results of the autocorrelation analysis, the larger correlation coefficient of 0.86 shown in FIG. 6, suggest a large systematic component.

The autocorrelation analysis and result has various applications in demand forecast calculations, in particular in setting forecast response factors and profile clustering.

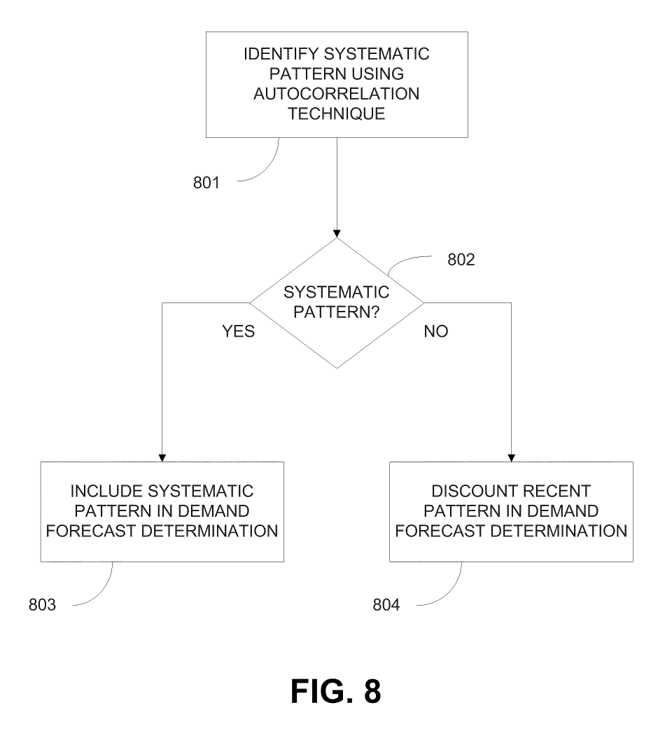

FIG. 8 is simple flow diagram illustrating the use of autocorrelation measurements in the determination of demand forecasts. When a product's sales variation is determined to be due primarily systematic patterns, as indicated by a low autocorrelation coefficient (steps 801 and 802), the accuracy of demand predictions and forecasts can be improved by understanding and modeling the underlying pattern in the demand forecast process, step 803. On the other hand, when variations in sales are determined to be merely random, these variations are best discounted when determining demand forecasts, step 804.

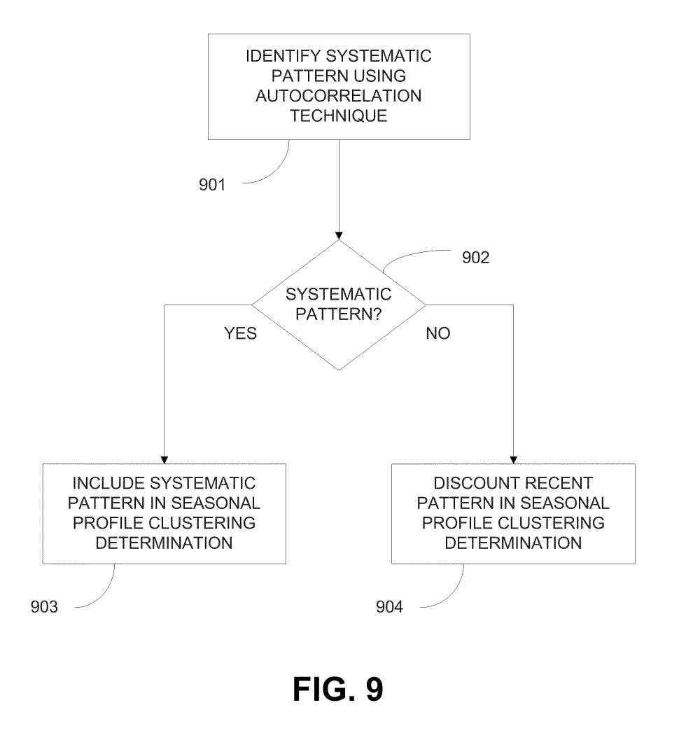

FIG. 9 is simple flow diagram illustrating the use of autocorrelation measurements in the process for selecting a seasonal profile for a product. When a product's sales variation is determined to be due primarily to systematic patterns, as indicated by a high autocorrelation coefficient (steps 901 and 902), the systematic pattern should be included in the process for associating the product with a seasonal profile, step 903. On the other hand, when variations in sales are merely random, these variations are best discounted when determining a seasonal profile for the product.

### CONCLUSION

The Figures and description of the invention provided above reveal a novel method, based on autocorrelation techniques, for measuring the relative significance of the systematic versus random components of product sales data. The results of this determination can be used to improve product demand forecast and product seasonal profile determinations. The method does not rely on repeating sales pattern over multiple years, it can be used when less than a year of data is available, as well as when multiple years of data is available.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching.

What is claimed is:

1. A computer-implemented method for forecasting product demand for a product, the method comprising the steps of:
maintaining, on a computer, an electronic database of historical product demand information for said product, said historical product demand information comprising a series of demand observations;
analyzing, by said computer, said historical product demand information to determine a correlation between recent values of said demand observations and past values of said demand observations, and determining an autocorrelation coefficient representing a measurement of said correlation, wherein a high value of said autocorrelation coefficient indicates a systematic pattern in said recent values of said demand observations, and a low value of said autocorrelation coefficient indicates a random pattern in said recent values of said demand observations; and
including said systematic pattern into a product demand forecast for said product when said autocorrelation coefficient comprises a high value.

2. The computer-implemented method for forecasting product demand for a product in accordance with claim 1, wherein:
series of demand observations comprises a series of weekly demand observations.

3. The computer-implemented method for forecasting product demand for a product in accordance with claim 2, wherein:
said series of weekly demand observations comprises less than one year of weekly demand observations; and
said step of analyzing said historical product demand information to determine a correlation between recent values of said demand observations and past values of said demand observations comprises comparing recent weekly demand observations with one-week prior weekly demand observations.

4. The computer-implemented method for forecasting product demand for a product in accordance with claim 2, wherein:
said series of weekly demand observations comprises multiple years of weekly demand observations; and
said step of analyzing said historical product demand information to determine a correlation between recent values of said demand observations and past values of said demand observations comprises comparing recent weekly demand observations with an average of corresponding week, prior years, weekly demand observations.

5. A computer-implemented method for forecasting product demand for a product, the method comprising the steps of:
maintaining, on a computer, an electronic database of historical product demand information for said product, said historical product demand information comprising a series of demand observations;
analyzing, by said computer, said historical product demand information to determine a correlation between recent values of said demand observations and past values of said demand observations, and determining an autocorrelation coefficient representing a measurement of said correlation, wherein a high value of said autocorrelation coefficient indicates a systematic pattern in said recent values of said demand observations, and a low value of said autocorrelation coefficient indicates a random pattern in said recent values of said demand observations; and
determining, by said computer, a seasonal demand profile for said product based on said systematic pattern when said autocorrelation coefficient comprises a high value.

6. The computer-implemented method for forecasting product demand for a product in accordance with claim 5, wherein:
series of demand observations comprises a series of weekly demand observations.

7. The computer-implemented method for forecasting product demand for a product in accordance with claim 6, wherein:
said series of weekly demand observations comprises less than one year of weekly demand observations; and
said step of analyzing said historical product demand information to determine a correlation between recent values of said demand observations and past values of said demand observations comprises comparing recent weekly demand observations with one-week prior weekly demand observations.

8. The computer-implemented method for forecasting product demand for a product in accordance with claim 6, wherein:
said series of weekly demand observations comprises multiple years of weekly demand observations; and
said step of analyzing said historical product demand information to determine a correlation between recent values of said demand observations and past values of said demand observations comprises comparing recent weekly demand observations with an average of corresponding week, prior years, weekly demand observations.
